(19) United States
(12) Patent Application Publication
(10) Pub. No.: US 2022/0266652 A1
(43) Pub. Date: Aug. 25, 2022

(54) AIR-CONDITIONING DEVICE

(71) Applicant: MAGNA STEYR Fahrzeugtechnik AG & Co KG, Graz (AT)

(72) Inventors: Bernhard EISNER, Ligist (AT); Rudolf PUNTIGAM, Schwarzautal (AT); Jürgen SCHMIDT, St.Nikolai im Sausal (AT); Joachim WIESBAUER, Graz (AT)

(73) Assignee: MAGNA STEYR Fahrzeugtechnik AG & Co KG, Graz (AT)

(21) Appl. No.: 17/672,188

(22) Filed: Feb. 15, 2022

(30) Foreign Application Priority Data
Feb. 23, 2021 (DE) 102021201682.0

(51) Int. Cl. B60H 1/00

(52) U.S. Cl. CPC B60H 1/00328; B60H 1/00564

(57) ABSTRACT

A motor vehicle air-conditioning device that includes an air inlet channel, an air-conditioning system, an air extraction channel, and a rotary heat exchanger. The air inlet channel has a supply air inlet opening operable to facilitate flow of vehicle exterior air into the air inlet channel. The air-conditioning system has an air supply channel fluidically connected to the air inlet channel. The air extraction channel has a discharge air inlet opening operable to facilitate flow of the vehicle interior air into the air extraction channel and a discharge air outlet opening operable to facilitate discharge of the extracted interior air through the air extraction channel and the discharge air outlet opening. The rotary heat exchanger is operable to, in an operating state thereof, provide a heat exchange between the air inlet channel and the air extraction channel.

### CROSS-REFERENCE TO RELATED APPLICATIONS

The present application claims priority under 35 U.S.C. § 119 to German Patent Publication No. DE 102021201682.0 (filed on Feb. 23, 2021), which is hereby incorporated by reference in its complete entirety.

### TECHNICAL FIELD

Embodiments relate to an air-conditioning device for a motor vehicle and a motor vehicle having such an air-conditioning device.

### BACKGROUND

Known air-conditioning devices in motor vehicles use air-conditioning systems to condition the interior air in a motor vehicle. Primarily, the interior air in a vehicle is to be cooled. Air-conditioning systems may, however, generally also be used to change the relative humidity, filter out air constituents, or, for example, heat the air. For their operation, air-conditioning systems normally use a refrigerant circuit, wherein the refrigerant is processed for example via electric heating/cooling devices and/or compressors. During operation of an air-conditioning system, usually fresh air is drawn in from outside the vehicle and conducted in the conditioned state into the vehicle interior.

The processed air from the vehicle interior is usually discharged to the vehicle's environment again via a rear vehicle air outlet. The energy used to process the interior air, e.g., in the form of heat, is usually lost again with the discharged air.

### SUMMARY

One or more embodiments are to provide an air-conditioning device for a motor vehicle, and a motor vehicle with such an air-conditioning device operable to reduce energy losses from conditioning of a vehicle interior air by the air-conditioning device.

In accordance with one or more embodiments, an air-conditioning device for a motor vehicle, comprises: an air inlet channel with a supply air inlet opening operable to facilitate flow of vehicle exterior air into the air inlet channel; an air-conditioning system having an air supply channel fluidically connected to the air inlet channel; an air extraction channel having a discharge air inlet opening operable to facilitate flow of the vehicle interior air into the air extraction channel and a discharge air outlet opening operable to facilitate discharge of the extracted interior air through the air extraction channel and the discharge air outlet opening; and a rotary heat exchanger operable to, in an operating state thereof, provide a heat exchange between the air inlet channel and the air extraction channel.

In accordance with the air-conditioning device, an air-conditioning system is used to condition the vehicle interior air, the air-conditioning system being supplied with air via a supply air inlet opening, an air inlet channel, and an air supply channel. Also, the air inlet channel and the air supply channel need not be structurally delimited from one another but may, for example, also be formed by a single channel. In addition to the air inlet channel, the air-conditioning device also uses a channel to discharge air, namely, air from the interior of the vehicle. The interior air is discharged via a discharge air inlet opening, an air extraction channel, and a discharge air outlet opening.

In accordance with the air-conditioning device, in operating state of the rotary heat exchanger, i.e., when the rotor of the rotary heat exchanger is actively running, the rotary heat exchanger is operable to provide a heat exchange between the air inlet channel and the air extraction channel. Such a heat exchange simultaneously preconditions the supply air to the air-conditioning system, and thus, reduces the energy requirement for the air-conditioning of a vehicle. In addition, the temperature, relative humidity, and air quality in the interior of the vehicle may be enhanced. A rear air vent may preferably also be omitted completely, thereby also enhancing the acoustics in the interior cabin of the vehicle. Energy losses resulting from the use of a rear air vent may thus be reduced. For example, dry air may also be reduced in heating mode, the energy required for dehumidifying in cooling mode may be reduced, and the air quality may be enhanced by a reduction in recirculation air operation in cooling mode. Thus, overall, the energy requirement for air-conditioning of a vehicle is reduced with simultaneous enhancement in air quality and comfort.

In accordance with one or more embodiments, the air inlet channel and the air extraction channel are arranged adjacent to one another in a region of the rotary heat exchanger. The rotor of the rotary heat exchanger may preferably cover the air inlet channel and the air extraction channel. The entire cross-section of the air inlet channel and the entire cross-section of the air extraction channel extend through the rotor of the rotary heat exchanger. The respective diameters of the air inlet channel and the air extraction channel in the region of the rotary heat exchanger are approximately the same size. The rotor centre point of the rotary heat exchanger preferably lies centrally between the cross-sections of the air inlet channel and the air extraction channel.

In accordance with one or more embodiments, a discharge air fan may be arranged in the air extraction channel to draw the vehicle interior air through the discharge air inlet opening into the air extraction channel.

In accordance with one or more embodiments, a supply air fan may be arranged in the air inlet channel, in order to convey the vehicle exterior air through the air inlet channel to an interior opening of the air inlet channel.

In accordance with one or more embodiments, a flap member may be arranged on the supply air inlet opening and/or on the discharge air outlet opening in order to close and open the supply air inlet opening and/or the discharge air outlet opening. Particularly, a common flap member may be provided for a common closure and opening of the supply air inlet opening and the discharge air outlet opening. The supply air inlet opening and the discharge air outlet opening may be arranged directly adjacent to one another or formed as a common opening.

In accordance with one or more embodiments, a control unit (e.g., a computing device including at least one computer readable medium comprising a set of instructions to be executed by one or more processors of the computing device) may be configured to actuate the rotor of the rotary heat exchanger, i.e., at least activate and deactivate the rotor of the rotary heat exchanger, also to actuate the rotary with variable rotation speed. In addition to controlling the rotation speed of the rotor of the rotary heat exchanger, the control unit may also be operable to actuate the discharge air fan and the supply air fan in order to control the necessary volume flows for the supply and discharge air.

In accordance with one or more embodiments, an air filter may be arranged in the air inlet channel in order to filter the supply air.

In accordance with one or more embodiments, the supply air inlet opening and the discharge air outlet opening are arranged in a front wall of the motor vehicle, i.e., on the front side of the vehicle.

In accordance with one or more embodiments, a motor vehicle is not equipped with a rear air vent. Forced venting of the vehicle takes place exclusively via the air extraction channel and the discharge air outlet opening.

### DRAWING

One or more embodiments will be illustrated by way of example in the drawings and explained in the description hereinbelow g.

FIG. 1 is a schematic illustration of an air-conditioning device for a motor vehicle, in accordance with one or more embodiments.

### DESCRIPTION

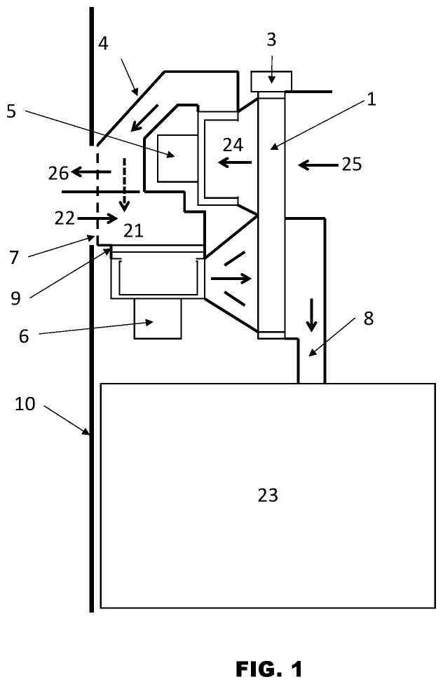

FIG. 1 illustrates an air-conditioning device for a motor vehicle having a front wall 10, in accordance with one or more embodiments. The air-conditioning device comprises an air inlet channel 21 with a supply air inlet opening 22 in the front wall 10. The supply air inlet opening 22 is operable to facilitate a flow of vehicle exterior air into the air inlet channel 21. The air-conditioning device furthermore comprises an air-conditioning system 23 having an air supply channel 8 that is fluidically connected to the air inlet channel 21.

The air-conditioning device also comprises an air extraction channel 24 with a discharge air inlet opening 25 operable to facilitate a flow of the vehicle interior air from the interior of the motor vehicle into the air extraction channel 24. The air extraction channel 24 has a discharge air outlet opening 26 operable to facilitate a discharge of the extracted interior air through the air extraction channel 24 and into the environment of the motor vehicle.

The air-conditioning device also comprises a rotary heat exchanger 1 which is operable, in operating state thereof, to provide a heat exchange between the air inlet channel 21 and the air extraction channel 24.

The air inlet channel 21 and the air extraction channel 24 are arranged next to one another in the region of the rotary heat exchanger 1, and the rotor of the rotary heat exchanger 1 covers the air inlet channel 21 and the air extraction channel 24. The diameters of the air inlet channel 21 and the air extraction channel 24 in the region of the rotary heat exchanger 1 are approximately the same size, so that half the diameter of the rotor of the rotary heat exchanger 1 covers the air inlet channel 21 and half covers the air extraction channel 24.

A discharge air fan 5 is arranged in the air extraction channel 24 in order to draw the vehicle interior air through the discharge air inlet opening 25 into the air extraction channel 24. A supply air fan 6 is arranged in the air inlet channel 21 in order to convey the vehicle exterior air through the air inlet channel 21 into an interior of the motor vehicle and to the air supply channel 8 for the air-conditioning system 23.

A common flap member 7 is arranged on the supply air inlet opening 22 and the discharge air outlet opening 26 so as to be able to optionally close and open the supply air inlet opening 22 and the discharge air outlet opening 26, and hence be able to switch between a supply air mode and a recirculation air mode of the air-conditioning device. An air filter 9 is arranged as a filter unit in the air inlet channel 21. The supply air inlet opening 22 and the discharge air outlet opening 26 are arranged in a front wall 10 at the front of the motor vehicle. The motor vehicle has no rear air vent.

The system of a rear air vent, previously common in motor vehicle designs, may be completely eliminated and replaced in the technical solution provided in accordance with one or more embodiments by placing an opening in the vehicle front wall 10. In this way, the energy potential of the air in the vehicle interior may be recovered by the rotary heat exchanger 1. For this, the opening may be formed in the region of the front wall 10, similar to that generally used in vehicles for drawing in fresh air for ventilation in the vehicle interior. The opening here, however, is divided into two regions, namely, a supply air region and a discharge air region. In order to transport air from the interior out of the vehicle again, a specifically provided fan (the discharge air fan 5) is installed. Its purpose is to automatically extract discharge air from the interior on closure of a door, and hence, counter a raised pressure in the vehicle passenger compartment, and also to draw this air through a heat exchanger (e.g., the rotary heat exchanger 1) in order to cause an energy transfer via the heat exchanger 1. In accordance with one or more embodiments, the vehicle having such an air-conditioning device has no valve (normally fitted at the vehicle rear) to automatically achieve a pressure balance on closure of the doors and hence, does not disadvantageously lose the energy contained in the vehicle interior air.

The heat exchanger 1 is a rotary heat exchanger which comprises individual flat aluminum plates and also a corrugated design. The heat exchanger 1 is provided with a ring gear which is driven by a drive motor 3. The heat exchanger 1 has a running surface on the periphery, which serves for mounting the heat exchanger 1 in the housing 4. The housing 4 serves for fixing the components and for air guidance. The drive speed of the drive motor 3 is adjustable, and thus, the rotation speed of the heat exchanger 1 can be selectively adapted as required.

These requirements for the rotary heat exchanger may for example be: temperature difference between exterior and interior, necessary volume flow for air-conditioning, and moisture recovery or avoidance in the interior/exterior air.

On the supply air side, a second fan (e.g., the supply air fan 6) is provided which is operable to supply fresh air to the interior. Here, however, the purpose of the supply air fan 6 is to also press the air drawn in from the vehicle exterior through the heat exchanger 1. On flowing through the heat exchanger 1, the exterior air is adapted to the desired interior conditions and thus the load on the air-conditioning system 23 is reduced. The fresh air may here be heated, cooled, dehumidified, and/or humidified. The fresh air pre-conditioned in this way thus contributes to energy-saving in the vehicle as a whole.

With respect to the additional fan on the discharge side (e.g., the discharge air fan 5), the discharge air fan 5 is controlled by the parameters of the air-conditioning system 23 (HVAC) and has the following purposes. 1) to ensure constant pressure conditions in the vehicle during operation. For this, it may perform the function of the omitted rear air vent; 2) to ensure an ideal contact flow onto the heat exchanger 1 on the discharge air side. The available surface area of the heat exchanger 1 should here be utilized to a maximum; and 3) on closure of a door, the discharge air fan 5 performs the function of the omitted rear air vent, and via adapted suction power, creates a reduced pressure and pleasant closing comfort for vehicle passengers.

In accordance with one or more embodiments, a control unit, such as, for example, a computing device including at least one computer readable medium comprising a set of instructions to be executed by one or more processors of the computing device, may be configured to actuate the rotor of the rotary heat exchanger, i.e., at least activate and deactivate the rotor of the rotary heat exchanger, also to actuate the rotary with variable rotation speed (i.e., control the rotational speed of the rotor). In addition to controlling the rotation speed of the rotor of the rotary heat exchanger, the control unit may also be operable to actuate the discharge air fan and the supply air fan in order to control the necessary volume flows for the supply and discharge air.

For a description of operating states, in principle, the functional method of the air-conditioning device does not change between the various operating states since the process for heating and cooling always remains the same, as described below.

1) Operating state at e.g. exterior temperature −10° C., low relative humidity inside and out. In a heating mode, the temperature in the interior is greater than the exterior temperature, and the blades are heated in the discharge air region. The discharge air from the interior transmits energy and humidity to the blades coming from the cold air region, and is cooled on its travel through the heat exchanger 1. The cold, fresh air from the supply air region is pressed by the fan 6 through the heated heat exchanger 1, and on its way absorbs energy and moisture from the blades. The fresh air is thus preheated and humidified. A differential pressure sensor performs the function of monitoring with respect to icing. If the cross-sections are reduced by icing, the rotation speed may be briefly reduced. Thus any ice already present in the discharge air side thaws and evaporates, whereby excessive cooling of the heat exchanger 1 and icing of the cross-sections are prevented or reduced.

2) Operating state at e.g. exterior temperature +18° C. In this state, no cooling and no heating are carried out since sufficient waste heat is available to maintain the set interior temperature. Only the two fans, namely, the supply air fan 6 and the discharge air fan 5, are in use, and the rotary heat exchanger 1 is stationary. No energy is required to rotate the heat exchanger 1. The same occurs in the case of recirculation air mode. Here there is no rotation of the heat exchanger 1. Additional requirements such as cleaning or de-icing requirements may however require rotation of the heat exchanger 1.

3) Operating state at e.g. exterior temperature +30° C., high exterior relative humidity.

In this state, the interior must be cooled via the air-conditioning system 23 (HVAC). For this, the intake air in the supply air region is cooled by the cooled blades of the heat exchanger 1 from the discharge air region. The heat exchanger 1 transports the absorbed energy from the supply air to the discharge air region and transmits this energy to the discharge air. The moisture which has condensed in the supply air region is brought by the heat exchanger 1 into the discharge air region, where it is evaporated again by dry discharge air and thus does not reach the air-conditioning system 23 (HVAC). In this way, additional energy may be saved.

### LIST OF REFERENCE SYMBOLS

1 Rotary heat exchanger
3 Drive motor
4 Housing
5 Discharge air fan
6 Supply air fan
7 Flap member
8 Air supply channel
9 Air filter
10 Front wall
21 Air inlet channel
22 Supply air inlet opening
23 Air-conditioning system
24 Air extraction channel
25 Discharge air inlet opening
26 Discharge air outlet opening

What is claimed is:

1. An air-conditioning device for a motor vehicle, the air-conditioning device comprising:
an air inlet channel with a supply air inlet opening operable to facilitate flow of vehicle exterior air into the air inlet channel;
an air-conditioning system having an air supply channel fluidically connected to the air inlet channel;
an air extraction channel having a discharge air inlet opening operable to facilitate flow of the vehicle interior air into the air extraction channel and a discharge air outlet opening operable to facilitate discharge of the extracted interior air through the air extraction channel and the discharge air outlet opening; and
a rotary heat exchanger operable to, in an operating state thereof, provide a heat exchange between the air inlet channel and the air extraction channel.

2. The air-conditioning device of claim 1, wherein the air inlet channel and the air extraction channel are arranged adjacent to one another in a rotary heat exchanger region.

3. The air-conditioning device of claim 2, wherein the rotary heat exchanger comprises a rotor that covers the air inlet channel and the air extraction channel.

4. The air-conditioning device of claim 3, wherein, in the rotary heat exchanger region, the diameter of the air inlet channel is approximately equal to the diameter of the air extraction.

5. The air-conditioning device of claim 1, further comprising a discharge air fan arranged in the air extraction channel, wherein the discharge air fan is operable to draw the vehicle interior air through the discharge air inlet opening into the air extraction channel.

6. The air-conditioning device of claim 5, further comprising a control unit operable to:
activate the discharge air fan upon closure of the vehicle door in a manner that vehicle interior air is automatically extracted upon closure of the vehicle door to counter a positive pressure in the vehicle passenger compartment,
actuate the rotor of the rotary heat exchanger, and
control a rotational speed of a rotor of the rotary heat exchanger.

7. The air-conditioning device of claim 1, further comprising a supply air fan arranged in the air inlet channel, wherein the supply air fan is operable to convey the vehicle exterior air through the air inlet channel to an interior opening of the air inlet channel.

8. The air-conditioning device of claim 1, further comprising a flap member arranged on the supply air inlet opening to close and open the supply air inlet opening.

9. The air-conditioning device of claim 1, further comprising a flap member arranged on the discharge air outlet opening to close and open the discharge air outlet opening.

10. The air-conditioning device of claim 1, further comprising a common flap member arranged on the supply air inlet opening and on the discharge air outlet opening to close and open the supply air inlet opening and the discharge air outlet opening.

11. The air-conditioning device of claim 1, further comprising an air filter arranged in the air inlet channel.

12. A motor vehicle, comprising:
a front wall; and
an air-conditioning device that includes:
an air inlet channel with a supply air inlet opening arranged in the front wall and operable to facilitate flow of vehicle exterior air into the air inlet channel;
—an air-conditioning system having an air supply channel fluidically connected to the air inlet channel;
an air extraction channel having a discharge air inlet opening arranged in the front wall and operable to facilitate flow of the vehicle interior air into the air extraction channel and a discharge air outlet opening operable to facilitate discharge of the extracted interior air through the air extraction channel and the discharge air outlet opening; and
—a rotary heat exchanger operable to, in an operating state thereof, provide a heat exchange between the air inlet channel and the air extraction channel.

13. The motor vehicle of claim 12, further comprising a discharge air fan arranged in the air extraction channel, wherein the discharge air fan is operable to draw the vehicle interior air through the discharge air inlet opening into the air extraction channel.

14. The motor vehicle of claim 13, further comprising a control unit operable to:
activate the discharge air fan upon closure of the vehicle door in a manner that vehicle interior air is automatically extracted upon closure of the vehicle door to counter a positive pressure in the vehicle passenger compartment,
actuate the rotor of the rotary heat exchanger, and
control a rotational speed of a rotor of the rotary heat exchanger.

15. The motor vehicle of claim 12, further comprising a supply air fan arranged in the air inlet channel, wherein the supply air fan is operable to convey the vehicle exterior air through the air inlet channel to an interior opening of the air inlet channel.

16. The motor vehicle of claim 12, further comprising a flap member arranged on the supply air inlet opening to close and open the supply air inlet opening.

17. The motor vehicle of claim 12, further comprising a flap member arranged on the discharge air outlet opening to close and open the discharge air outlet opening.

18. The motor vehicle of claim 12, further comprising a common flap member arranged on the supply air inlet opening and on the discharge air outlet opening in order to be able to close and open the supply air inlet opening and the discharge air outlet opening.

19. The motor vehicle of claim 12, further comprising an air filter arranged in the air inlet channel.

20. The motor vehicle of claim 12, wherein the motor vehicle has no rear air vent.
